(19) United States
(12) Patent Application Publication
(10) Pub. No.: US 2008/0205645 A1
(43) Pub. Date: Aug. 28, 2008

(54) Digital broadcast reception apparatus

(75) Inventor: Masanori Kawai, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd., Osaka (JP)

(21) Appl. No.: 12/068,859

(22) Filed: Feb. 12, 2008

(30) Foreign Application Priority Data
Feb. 13, 2007 (JP) 2007-031565

(51) Int. Cl. H04N 7/167

(52) U.S. Cl. 380/212

(57) ABSTRACT

A digital broadcast reception apparatus includes a first reception unit for receiving a certain digital broadcast, a second reception unit for receiving another digital broadcast, a control signal reception unit for receiving an update instruction signal that is instruction information indicating an update of software information, and a display control section for displaying, on a display, video images that correspond to contents of the certain digital broadcast received by the first reception unit. An IC card attached to the digital broadcast reception apparatus includes an update execution section which acquires the software information through the second reception unit and installs the acquired software information when the update instruction signal is received by the control signal reception unit.

This application is based on Japanese Patent Application No. 2007-031565 filed on Feb. 13, 2007, the contents of which are hereby incorporated by reference.

### BACKGROUND OF THE INVENTION

1. Field of the Invention

The present invention relates to a digital broadcast reception apparatus which is configured to be capable of receiving a digital broadcast and outputting contents of the digital broadcast onto a monitor in a manner to be visible from outside, and which is configured to be capable of receiving software information through a digital broadcast and installing the software information.

2. Description of Related Art

In recent years, with the spread of digital broadcasts, the two-way communication between a broadcasting station and a viewer has become possible, and a chargeable broadcast which charges a fee for every program has also become possible. A broadcast system which performs the chargeable broadcast requires a system which identifies viewers so that only the viewers allowed to view are permitted to view the program. In case of receiving, for example, a BS digital broadcast, an IC card termed “B-CAS (BS Conditional Access System) card” is required in every reception apparatus. More specifically, in order to decrypt (descramble) an encrypted (scrambled) broadcast signal, the viewer is required to make an agreement with the broadcasting station (program provider) to use the B-CAS card which stores decrypting information therein.

Regarding the broadcast system which performs the chargeable broadcast, various apparatuses, methods etc. have been proposed. JP-A-2007-13685, for example, discloses a reception apparatus into which an IC card endowed with a B-CAS card function and an S-CAS card function therein is inserted, and in which a viewer authentication is obtained by using the B-CAS card function within the IC card for limited reception broadcasts upon reception of a digital broadcast, or the S-CAS card function within the IC card for the limited reception broadcasts upon reception of a server type broadcast, so as to decrypt a contents signal. In accordance with this reception apparatus, both the encrypted digital broadcast and the server type broadcast can be received.

Meanwhile, in North America, open cable broadcasts have been started with the digitization of cable television. An IC card which is termed “cable card” and in which a CPU (Central Processing Unit) is packaged for decryption processing can be used so that a chargeable broadcast can be coped with. In addition, the CPU packaged in the cable card has a function of receiving and updating firmware through a cable.

In this system, the firmware within the cable card is updated with ease, and hence, the user-friendliness can be enhanced. However, while the CPU packaged in the cable card is receiving the firmware through the cable, the function required for receiving the broadcast is used for receiving the firmware. This causes the problem that the user can not view the television program during such a period, thereby, decreasing the user-friendliness.

### SUMMARY OF THE INVENTION

The present invention is made in view of the above problem, and an object of the present invention is to provide a digital broadcast reception apparatus capable of updating software information in a convenient manner.

In order to achieve the object, a digital broadcast reception apparatus in the present invention is configured to be capable of receiving a digital broadcast and outputting contents of the digital broadcast to a monitor in a manner to be visible from outside and configured to be capable of receiving software information through a digital broadcast and installing the software information, and includes: first reception means for receiving a certain digital broadcast; second reception means for receiving another digital broadcast; third reception means for receiving an update instruction signal which is instruction information indicating an update of the software information; display control means for displaying, on the monitor, video images corresponding to contents of said certain digital broadcast received by the first reception means; and update execution means for acquiring the software information through the second reception means and installing the software information thus acquired when the update instruction signal is received by the third reception means.

According to this configuration, a certain digital broadcast is received by the first reception means, and video images corresponding to the received certain digital broadcast are displayed on the monitor. Besides, when the update instruction signal which is the instruction information indicating the update of the firmware information is received by the third reception means, the firmware information transmitted through another digital broadcast is received and acquired by the second reception means, and the acquired firmware information is installed by the update execution means. Therefore, the firmware information can be updated in a user-friendly manner.

In other words, another reception means (first reception means) for receiving the digital broadcast is provided separately from the reception means (second reception means) for receiving the firmware information. Therefore, even when the firmware information is being received through the second reception means, unencrypted contents of the digital broadcast received through the first reception means can be still viewed. Accordingly, the firmware information can be updated in a user-friendly manner.

According to another aspect of the invention, the digital broadcast reception apparatus further includes: decryption information storage means for storing therein firmware information for decrypting encrypted contents of the digital broadcast; and decryption means that, when encrypted contents of the digital broadcast are received by the first reception means or the second reception means, decrypts the encrypted contents of the digital broadcast thus received, by means of the firmware information stored in the decryption information storage means. When the encrypted contents of the digital broadcast are received by the first reception means or the second reception means, the display control means displays, on the monitor, video images corresponding to a result obtained by decrypting the encrypted contents of the digital broadcast by the decryption means, and the software information is the firmware information stored in the decryption information storage means.

According to this configuration, the firmware information for decrypting the encrypted contents of the broadcast is stored in the decryption information storage means. Therefore, when encrypted contents of the digital broadcast are received by the first reception means or the second reception means, the received encrypted contents of the digital broadcast are decrypted through the firmware information stored in the decryption information storage means by the decryption means, and video images corresponding to a result obtained by decrypting the encrypted contents of the digital broadcast are displayed on the monitor. Since the encrypted contents of the digital broadcast can be decrypted and viewed in this way, the user-friendliness can be enhanced.

Additionally, according to this configuration, since the software information is the firmware information stored in the decryption information storage means, the firmware information stored in the decryption information storage means can be updated in a user-friendly manner.

According to still another aspect of the invention, the digital broadcast reception apparatus further includes communication means for communicating with an IC card attached thereto in a detachable manner. The update execution means, the decryption information storage means, and the decryption means are formed within the IC card which is attached to the communication means.

According to this configuration, communication is performed with the IC card which is formed by the update execution means, the decryption information storage means, and decryption means, and the IC card is configured to be detachable. Therefore, the user-friendliness can be further enhanced.

More specifically, the IC card in which functions concerning decryption processing are packaged is arranged to be detachable. Therefore, since the broadcasting station (program provider) can implement the alterations or the like of the functions of the decryption processing by giving a user a notice that the user is requested to attach a new IC card, the user-friendliness is further enhanced.

According to still another aspect of the invention, in the digital broadcast reception apparatus as configured above, the first reception means, the second reception means, and the third reception means receive information through a cable, and the third reception means receives the update instruction signal through a predetermined specific frequency band which is different from a frequency band of a broadcast signal.

According to this configuration, information is received through the cable by the first reception means, the second reception means, and the third reception means, and the update instruction signal is received through a predetermined specific frequency band different from the frequency bands of broadcast signals, by the third reception means. Therefore, the update instruction signal can be more securely received.

To be more specific, since the update instruction signal is received through the predetermined specific frequency band (for example, a frequency band between the UHF (Ultra High Frequency) frequency band and the VHF (Very High Frequency) frequency band) different from the frequency band of the broadcast signal, the frequency band of the update instruction signal can be reliably separated from the frequency band of the broadcast wave by a band-pass filter or the like. Accordingly, the update instruction signal can be more securely received.

According to still another aspect of the invention, in the digital broadcast reception apparatus according the aforementioned configuration, when the update instruction signal is received by the third reception means, the display control means displays, on the monitor, information indicating that the encrypted contents of the digital broadcast can not be displayed.

According to this configuration, when the update instruction signal is received by the third reception means, information which indicates to the effect that encrypted contents of the digital broadcast cannot be displayed, is displayed on the monitor. Therefore, the user-friendliness can be further improved.

More specifically, while firmware information stored in the decryption information storage means is being updated, the decryption processing cannot be executed, and hence, the encrypted contents of the digital broadcast cannot be displayed. Therefore, such information is indicated on the monitor, whereby the user can understand that the encrypted contents of the digital broadcast cannot be displayed. Accordingly, the user-friendliness can be enhanced still further.

### BRIEF DESCRIPTION OF THE DRAWINGS

FIG. 1 is a block diagram showing an example of the configuration of a digital broadcast reception apparatus according to the present invention.

FIG. 2 is a data flow diagram showing an example of a data flow when a television broadcast is received in the digital broadcast reception apparatus.

FIG. 3 is a data flow diagram showing an example of a data flow when an update instruction signal is received in the digital broadcast reception apparatus.

FIG. 4 is a data flow diagram showing an example of a data flow when firmware information is received in the digital broadcast reception apparatus.

FIG. 5 is a flow chart showing an example of the operation of the digital broadcast reception apparatus.

FIG. 6 is a block diagram showing an example of the configuration of a conventional digital broadcast reception apparatus.

### DETAILED DESCRIPTION OF PREFERRED EMBODIMENTS

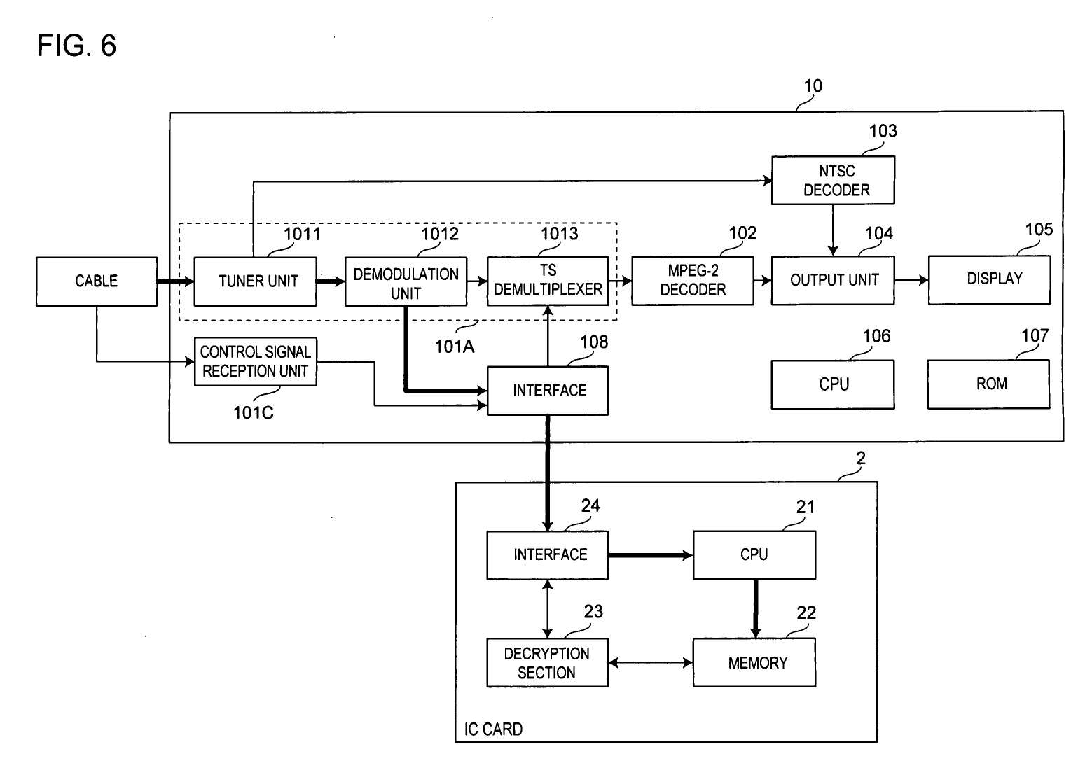

Now, embodiments of the present invention will be described with reference to the drawings. FIG. 6 is a block diagram showing an example of the configuration of a conventional digital broadcast reception apparatus. The broadcast receiver 10 is an apparatus which receives analog and digital television broadcasts through a cable so as to output them to a display 105. This broadcast receiver 10 includes a reception unit 101A, a control signal reception unit 101C, an MPEG-2 decoder 102, an NTSC decoder 103, an output unit 104, the display 105, a CPU 106, a ROM 107, and an interface 108.

The CPU (Central Processing Unit) 106 controls an entire operation of the broadcast receiver 10. The ROM (Read Only Memory) 107 is a memory in which a control program for operating the CPU 106 and the like are stored. The interface 108 is so configured that an IC card 2 can be detachably connected for performing the communication with the IC card 2.

The reception unit 101A receives the television broadcast through the cable and demodulates the received broadcast signal and includes a tuner unit 1011, a demodulation unit 1012, and a TS demultiplexer 1013. The control signal reception unit 101C receives through the cable an update instruction signal which is instruction information indicating an update of the firmware.

The tuner unit 1011 serves to select the broadcast of a preset channel from television broadcast waves transmitted through the cable. The demodulation unit 1012 demodulates a signal of output information from the tuner unit 1011. The TS (Transport Stream) demultiplexer 1013 demultiplexes the output information demodulated by the demodulation unit 1012, every sort, and outputs the demultiplexed information.

The MPEG-2 (Motion Picture Experts Group) decoder 102 decodes the video information outputted from the TS demultiplexer 1013 into video information in an uncompressed format.

The NTSC (National Television Standards Committee) decoder 103 converts a television signal of NTSC format from the analog broadcast into video information.

The output unit 104 outputs the video information decoded by the MPEG-2 decoder 102 or the video information from the NTSC decoder 103, to the display 105. The display 105 is configured with an LCD (Liquid Crystal Display), a PDP (Plasma Display Panel), or the like and displays video images corresponding to the television signal outputted from the output unit 104.

The IC card 2 operates when the encrypted digital broadcast has been received from the reception unit 101A so as to decrypt the received encrypted contents of the digital broadcast and includes a CPU 21, a memory 22, a decryption section 23, and an interface 24.

The CPU 21 performs the control of the whole IC card 2. The interface 24 performs the communication with the broadcast receiver 10. The memory 22 is a nonvolatile memory such as a flash memory in which firmware information for the decryption section 23 to execute decryption processing is stored. The decryption section 23 operates when the encrypted contents of the digital broadcast are received from the reception unit 101A, so as to decrypt the encrypted contents inputted from the demodulation unit 1012 through the interface 24 and to output decrypted video information to the TS (Transport Stream) demultiplexer 1013 through the interface 24.

When the update instruction signal indicating an update of the firmware is received through the control signal reception unit 101C, the CPU 21 causes the CPU 106 to set the tuner unit 1011 to a predetermined channel (frequency) for receiving the firmware information. Here, as indicated by thick lines in the figure, the firmware information signal received from the tuner unit 1011 is demodulated by the demodulation unit 1012 and stored in the memory 22 through the interfaces 108 and 24. Accordingly, while the firmware information is being received, the tuner unit 1011 and the demodulation unit 1012 are used for the reception of the firmware information, and, hence, a user cannot view the television program.

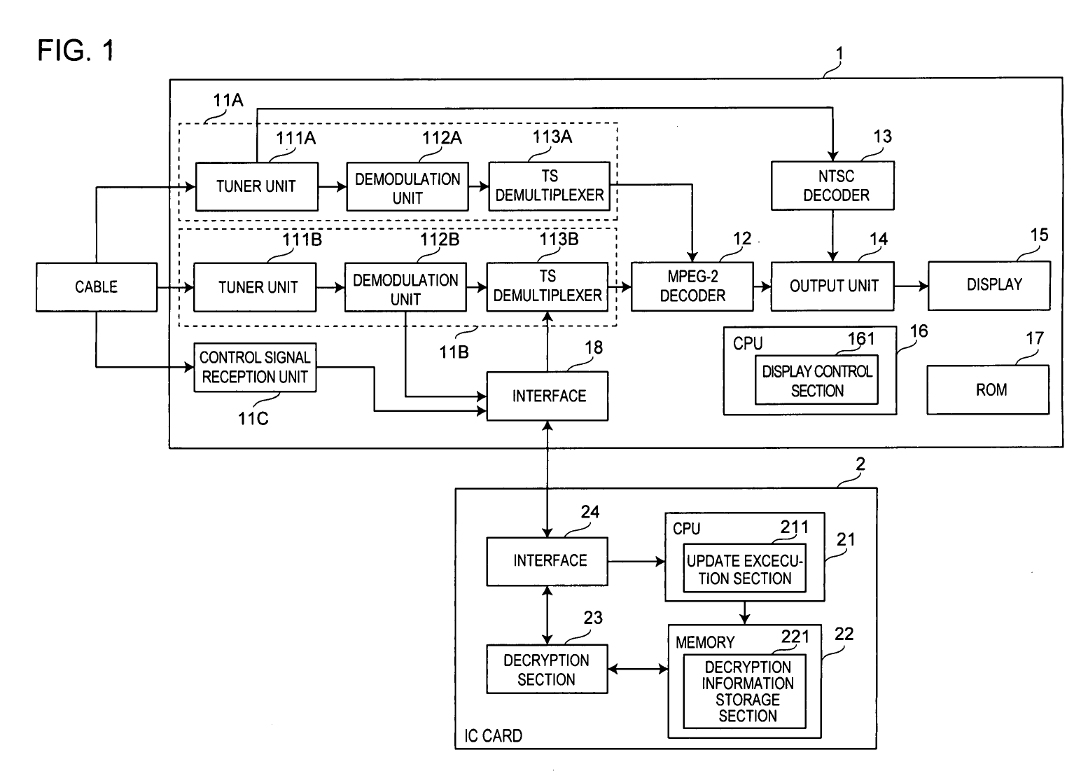

FIG. 1 is a block diagram showing an example of the configuration of a digital broadcast reception apparatus according to the present invention. The broadcast receiver 1 receives analog and digital television broadcasts through a cable, so as to output them to a display 15. This broadcast receiver 1 includes a reception unit 11A, a reception unit 11B, a control signal reception unit 11C, an MPEG-2 decoder 12, an NTSC decoder 13, an output unit 14, the display 15, a CPU 16, a ROM 17, and an interface 18.

The CPU 16 controls the operation of the whole broadcast receiver 1. The ROM (Read Only Memory) 17 is a memory in which a control program for operating the CPU 16 and the like are stored. The interface 18 (corresponding to communication means) is so configured that the IC card 2 can be detachably connected thereto and performs communication with the IC card 2.

Each of the reception unit 11A (corresponding to first reception means) and the reception unit 11B (corresponding to second reception means) receives the television broadcast through the cable and demodulates the received broadcast signal. Since the reception units 11A and 11B have substantially the same configuration, the reception unit 11A will be described for the sake of convenience here. The reception unit 11A includes a tuner unit 111A, a demodulation unit 112A, and a TS demultiplexer 113A. The control signal reception unit 11C (corresponding to third reception means) receives, through the cable, an update instruction signal which is instruction information indicating an update of firmware. Here, the control signal reception unit 11C receives the update instruction signal through a preset specified frequency band (for example, a frequency band between the UHF frequency band and the VHF frequency band) which is different from the frequency band of the broadcast signal.

The tuner unit 111A serves to select the broadcast of a preset channel from the television broadcast waves through the cable. The demodulation unit 112A demodulates a signal of output information from the tuner unit 111A. The TS demultiplexer 113A demultiplexes the output information demodulated by the demodulation unit 112A, every sort, so as to output the demultiplexed output information.

The MPEG-2 decoder 12 decodes the video information outputted from the TS demultiplexers 113A and 113B into video information in an uncompressed format.

The NTSC (National Television Standards Committee) decoder 13 converts a television signal of NTSC format from the analog broadcast into video information.

The output unit 14 outputs the video information decoded by the MPEG-2 decoder 12 or the video information from the NTSC decoder 13, to the display 15. The display 15 (corresponding to a monitor) is configured with an LCD (Liquid Crystal Display), a PDP (Plasma Display Panel), or the like and displays video images corresponding to the television signal outputted from the output unit 14.

Additionally, the CPU 16 functionally includes a display control section 161. Here, the CPU 16 fetches the control program stored in the ROM 17 or the like in advance and runs the fetched program to, thereby, operate as the functional section for the display control section 161 or the like.

The display control section 161 (corresponding to display control means) is the functional section which causes the display 15 to display the video images which correspond to the analog broadcast or digital broadcast received by the reception unit 11A or 11B. To be more specific, when the analog broadcast signal is received by the tuner unit 111A or 111B, the display control section 161 converts the received signal into the video information through the NTSC decoder 13 and causes, through the output unit 14, the display 15 to display the video information.

Furthermore, when unencrypted contents of the digital broadcast are received by the tuner unit 111A (or the tuner unit 111B), the display control section 161 makes the demodulation unit 112A (or the demodulation unit 112B) demodulate the received signal and the TS demultiplexer 113A (or the TS demultiplexer 113B) extract video information from the demodulated output information. Further, it makes the MPEG-2 decoder 12 decode the extracted video information and the display 15 display the decoded video information thereon.

In addition, when the encrypted digital broadcast is received by the reception unit 11A or 11B, the display control section 161 makes the display 15 display thereon video images which correspond to the contents of the digital broadcast decrypted by a decryption section 23. To be more specific, when encrypted contents of the digital broadcast are received by the tuner unit 111A (or the tuner unit 111B), the display control section 161 makes the demodulation unit 112A (or the demodulation unit 112B) demodulate the received signal, the decryption section 23 decrypt (descramble) the demodulated output information, and the TS demultiplexer 113A (or the TS demultiplexer 113B) extract video information from the decrypted (descrambled) output information. Further, it makes the MPEG-2 decoder 12 decode the extracted video information and the output unit 14 display the decoded video information on the display 15.

Further, when the update instruction signal has been received by the control signal reception unit 11C, the display control section 161 makes the display 15 display thereon information indicating that the encrypted contents of the digital broadcast cannot be displayed.

To be more specific, the display control section 161 causes the output unit 14 to display on the display 15, as an OSD (On-Screen Display), the specified information indicating that the encrypted contents of the digital broadcast cannot be displayed during a period starting when the display control section 161 receives from the CPU 21 (update execution section 211 to be explained later) information indicating that the update instruction signal has been received, and ending when the display control section 161 receives from the CPU 21 (update execution section 211 to be explained later) information indicating that the update has been completed. The specified information is, for example, character information indicating “Software for displaying scrambled broadcast is being updated. The scrambled broadcast cannot be displayed!”

The IC card 2 operates, when the encrypted digital broadcast signal has been received from the reception unit 11A (or 11B), so as to decrypt the received encrypted contents of the digital broadcast and includes the CPU 21, the memory 22, the decryption section 23, and the interface 24.

The CPU 21 performs the control of the whole IC card 2. The interface 24 performs communication with the broadcast receiver 1. The memory 22 is a nonvolatile memory such as a flash memory in which firmware information for the decryption section 23 to execute decryption processing is stored. The decryption section 23 (corresponding to decryption means) operates when the encrypted digital broadcast has been received from the reception unit 11A (or 11B) so as to decrypt the encrypted contents of the digital broadcast inputted from the demodulation unit 112A (or 112B) through the interface 24 and to output decrypted video information to the TS demultiplexer 113A (or 113B) through the interface 24.

The CPU 21 functionally includes the update execution section 211, and the memory 22 functionally includes a decryption information storage section 221. Here, the CPU 21 fetches a control program stored in an unillustrated ROM or the like in advance and runs the fetched program. Thus, the CPU 21 functions as a functional section such as the update execution section 211, and causes the memory 22 to function as a functional section such as the decryption information storage section 221.

The decryption information storage section 221 (corresponding to decryption information storage means) is the functional section in which the firmware information acquired by the update execution section 211 is stored. The update execution section 211 (corresponding to update execution means) is the functional section which operates, when the control signal reception unit 11C receives the update instruction signal which is the instruction information indicating an update of the firmware, so as to acquire the firmware information through the reception unit 11B and to install the acquired firmware information.

More specifically, when the update instruction signal is received by the control signal reception unit 11C, the update execution section 211 causes the CPU 16 to set the tuner unit 111B to a predetermined channel (frequency) for receiving the firmware information and to, thereby, receive the firmware information. In addition, the update execution section 211 makes the CPU 16 use the demodulation unit 112B to demodulate the firmware information received by the tuner unit 111B. Further, the update execution section 211 acquires the firmware information demodulated by the demodulation unit 112B through the interfaces 18 and 24 and stores the acquired information in the decryption information storage section 221. After the completion of the acquisition of the firmware information, the update execution section 211 installs the firmware.

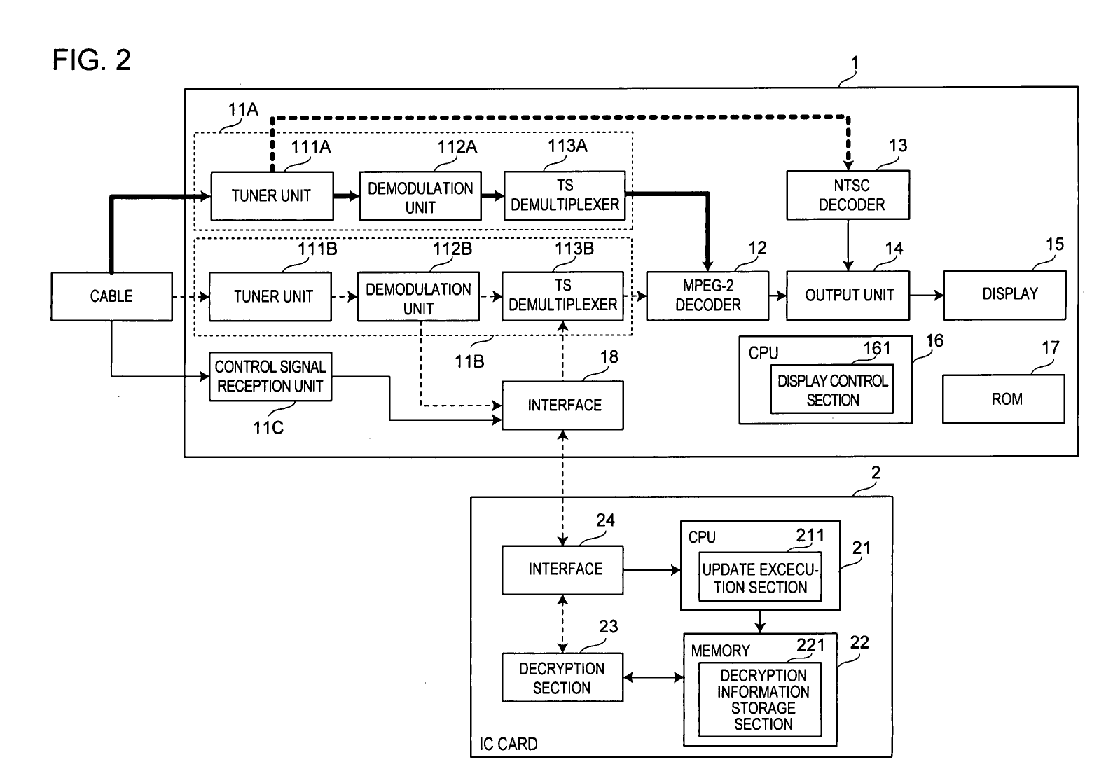

FIG. 2 is a data flow diagram showing an example of a data flow when a television broadcast is received in the digital broadcast reception apparatus. Incidentally, the control of the data flow indicated below is entirely performed by the display control section 161. First, a description will be given of a case where an analog broadcast is received through the reception unit 11A in the broadcast receiver 1. As indicated by thick broken lines in FIG. 2, a signal received by the reception unit 11A is converted into video information by the NTSC decoder 13, and the video information is displayed on the display 15 by the output unit 14.

Next, a description will be given of a case where unencrypted contents of the digital broadcast are received through the reception unit 11A in the broadcast receiver 1. As indicated by thick solid lines in FIG. 2, a signal received by the reception unit 11A is demodulated by the demodulation unit 112A, and video information is extracted from the demodulated output information by the TS demultiplexer 113A. Further, the extracted video information is decoded by the MPEG-2 decoder 12, and the decoded video information is displayed on the display 15 by the output unit 14.

Further, a description will be given of a case where encrypted contents of the digital broadcast are received through the reception unit 11B in the broadcast receiver 1. As indicated by fine broken lines in FIG. 2, a signal received by the tuner unit 111B is demodulated by the demodulation unit 112B, the demodulated output information is decrypted (descrambled) by the decryption section 23 through the interfaces 18 and 24, and video information is extracted from the decrypted (descrambled) output information by the TS demultiplexer 113B. Further, the extracted video information is decoded by the MPEG-2 decoder 12, and the decoded video information is displayed on the display 15 through the output unit 14.

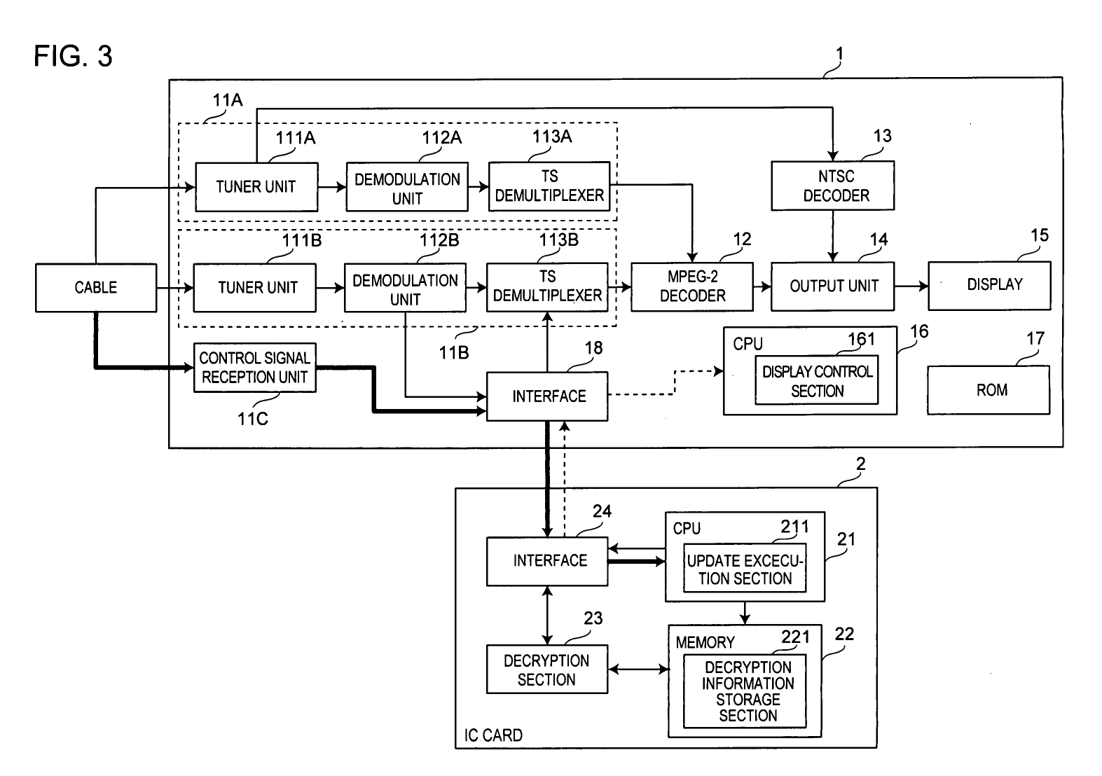

FIG. 3 is a data flow diagram showing an example of a data flow when an update instruction signal is received in the digital broadcast reception apparatus. As indicated by thick solid lines in FIG. 3, the update instruction signal received by the control signal reception unit 11C is then received by the update execution section 211 through the interfaces 18 and 24. In addition, when the update instruction signal is received by the update execution section 211, instruction information indicating the acquisition of the firmware information is outputted to the CPU 16 through the interfaces 24 and 18 by the update execution section 211, as indicated by broken lines in FIG. 3.

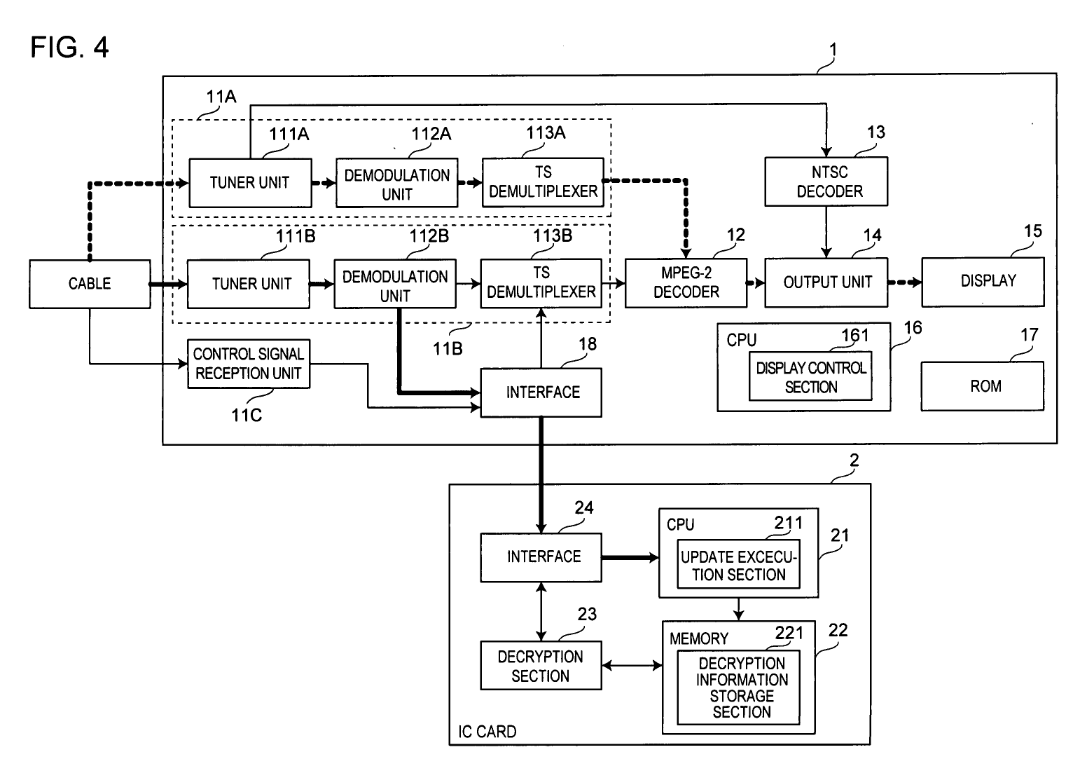

FIG. 4 is a data flow diagram showing an example of a data flow when firmware information is received in the digital broadcast reception apparatus. Here, a description will be given of a case where unencrypted contents of the digital broadcast are being received through the reception unit 11A. As indicated by thick broken lines in FIG. 4, the signal of the digital broadcast received by the reception unit 11A is demodulated by the demodulation unit 112A, and video information is extracted from the demodulated output information by the TS demultiplexer 113A in compliance with an instruction from the display control section 161. Further, the extracted video information is decoded by the MPEG-2 decoder 12, and the decoded video information is now being displayed on the display 15 by the output unit 14.

Furthermore, the control of a data flow described below is performed on the basis of an instruction from the update execution section 211. The tuner unit 111B is set for a predetermined channel (frequency) for receiving firmware information, and the firmware information is received. In addition, the firmware information received by the tuner unit 111B is demodulated by the demodulation unit 112B. Further, the firmware information demodulated by the demodulation unit 112B is stored in the decryption information storage section 221 through the interfaces 18 and 24.

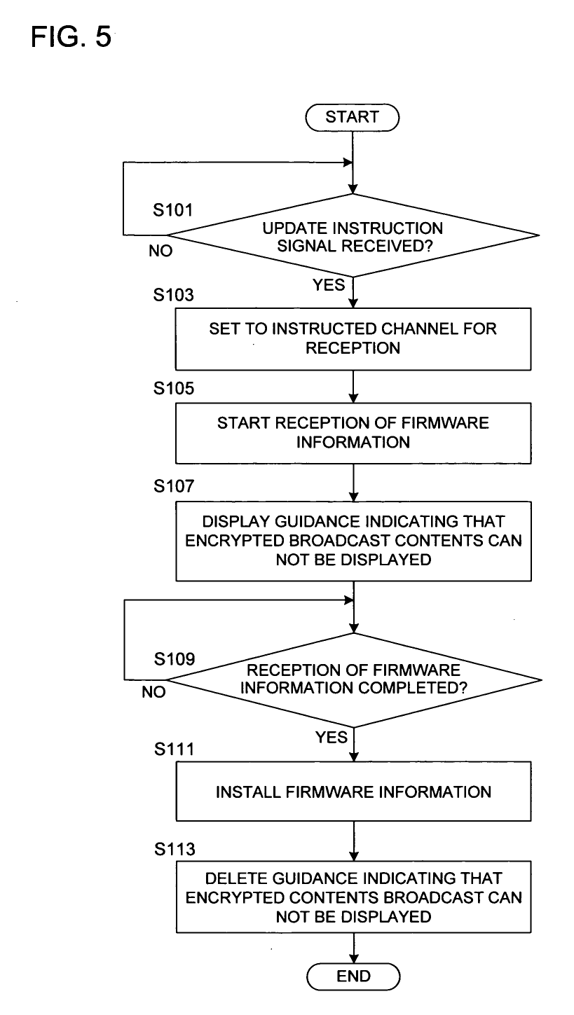

FIG. 5 is a flow chart showing an example of the operation of the digital broadcast reception apparatus (particularly, of the CPU 16 and the CPU 21). First, the update execution section 211 (S101) determines whether or not an update instruction signal has been received. Subject to the determination that the update instruction signal has not been received (“NO” in the step S101), processing is held in a wait state. On the other hand, subject to the determination that the update instruction signal has been received (“YES” in the step S101), the tuner unit 111B (or 111A) is set for a predetermined channel (frequency) for receiving the firmware information (S103). Then, the reception of the firmware information is started through the tuner unit 111B (or 111A) by the update execution section 211 (S105).

Subsequently, information from the update execution section 211, which indicates that the update instruction signal has been received, is received by the display control section 161, and guidance information indicating to the effect that the encrypted contents of the digital broadcast cannot be displayed, is displayed on the display 15 by the display control section 161 (S107). Then, the update execution section 211 determines whether or not the reception of the firmware information has been completed (S109). Subject to the determination that the reception has not been completed (“NO” in the step S109), the processing is held in a wait state. On the other hand, subject to the determination that the reception has been completed (“YES” in the step S109), the received firmware information is installed by the update execution section 211 (S111). Then, information from the update execution section 211, which indicates to the effect that the update of the firmware has been completed, is received by the display control section 161, and the guidance information displayed in the step S107 is erased by the display control section 161 (S113), whereupon the processing is ended.

In this way, a certain digital broadcast is received by the reception unit 11A, and video images corresponding to the received certain digital broadcast are displayed on the display 15. Besides, when the update instruction signal which is the instruction information indicating the update of the firmware information has been received by the control signal reception unit 11C, the firmware information transmitted through another digital broadcast is received and acquired by the reception unit 11B, and the acquired firmware information is installed by the update execution section 211. Therefore, the firmware information can be updated in a user-friendly manner.

In other words, the reception means (reception unit 11A) for receiving the digital broadcast is provided separately from the reception means (reception unit 11B) for receiving the firmware information. Therefore, even when the firmware information is being received through the reception unit 11B, unencrypted contents of the digital broadcast received through the reception unit 11A can be still viewed. Accordingly, the firmware information can be updated in a user-friendly manner (refer to FIG. 4).

In addition, the firmware information for decrypting the encrypted contents of the broadcast is stored in the decryption information storage section 221. Therefore, when encrypted contents of the digital broadcast are received by the reception unit 11A or 11B, the received encrypted contents of the digital broadcast are decrypted through the firmware information stored in the decryption information storage section 221 by the decryption section 23, and video images corresponding to the decrypted contents are displayed on the display 15. Since the encrypted contents of the digital broadcast can be decrypted and viewed in this way, the user-friendliness can be enhanced (refer to the fine broken lines in FIG. 2).

Further, since the firmware information is stored in the decryption information storage section 221, the firmware information stored in the decryption information storage section 221 can be updated in a user-friendly manner.

Moreover, communication is performed with the IC card 2 which is formed with the update execution section 211, the decryption information storage section 221, and decryption section 23, and the IC card 2 is configured so as to be detachable. Therefore, the user-friendliness can be further enhanced.

Specifically, the IC card 2 in which functions concerning decryption processing are packaged is arranged to be detachable. Therefore, since the broadcasting station (program provider) can implement the alterations or the like of the functions of the decryption processing by giving a user a notice that the user is requested to attach a new IC card 2, the user-friendliness is further enhanced.

Additionally, information is received through a cable by the reception unit 11A, the reception unit 11B, and the control signal reception unit 11C, and the update instruction signal is received through a predetermined specific frequency band different from the frequency bands of broadcast signals, by the control signal reception unit 11C. Therefore, the update instruction signal can be more securely received.

To be more specific, since the update instruction signal is received through the predetermined specific frequency band (for example, a frequency band between the UHF (Ultra High Frequency) frequency band and the VHF (Very High Frequency) frequency band) different from the frequency band of the broadcast signal, the frequency band of the update instruction signal can be reliably separated from the frequency band of the broadcast wave by a band-pass filter or the like. Accordingly, the update instruction signal can be more securely received.

Moreover, when the update instruction signal is received by the control signal reception unit 11C, information which indicates to the effect that encrypted contents of the digital broadcast cannot be displayed, is displayed on the display 15. Therefore, the user-friendliness can be further improved.

More specifically, while firmware information stored in the decryption information storage section 221 is being updated, the decryption processing cannot be executed, and hence, the encrypted contents of the digital broadcast cannot be displayed. Therefore, such information is indicated on the display 15, whereby the user can understand that the encrypted contents of the digital broadcast cannot be displayed. Accordingly, the user-friendliness can be enhanced still further.

It is to be noted that the present invention is also applicable to the following cases. (A) In the embodiment, although the description has been given of the digital broadcast reception apparatus that includes the broadcast receiver 1 which receives the analog and digital broadcasts, the present invention is also applicable to a case in which the digital broadcast reception apparatus is a broadcast reception apparatus which receives only the digital broadcast.

(B) In the embodiment, although the description has been given of a case in which the monitor is the display 15 provided in the broadcast receiver 1, the monitor may be provided as an independent apparatus from the broadcast receiver 1. For example, the monitor may be a monitor provided for a personal computer or the like.

(C) In the embodiment, although the description has been given of a case in which the CPU 16 and the CPU 21 are provided with the functional sections such as the display control section 161 and the update execution section 211, it is also possible to form at least one of the functional sections, i.e., the display control section 161 and the update execution section 211, by hardware such as a circuit.

(D) In the embodiment, although the description has been given of a case in which the software information is the firmware information stored in the decryption information storage section 221, this may be firmware information in another form or software information in another form. For example, the software information may be in a form of firmware information that functions as a driver of a unit provided in the digital broadcast reception apparatus. Additionally, for example, the software information may be in a form of software information such as software for displaying a menu screen or the like that is used in the digital broadcast reception apparatus.

(E) In the embodiment, although the description has been given of a case in which the software information is stored in the IC card 2 that is configured to be detachably mounted, it may be stored in the ROM 17 or the like that is provided in the digital broadcast reception apparatus. In such a case, the update processing is simplified.

What is claimed is:

1. A digital broadcast reception apparatus configured to be capable of receiving a digital broadcast and outputting contents of the digital broadcast to a monitor in a manner to be visible from outside and configured to be capable of receiving software information through a digital broadcast and installing the software information, comprising:
first reception means for receiving a certain digital broadcast;
second reception means for receiving another digital broadcast;
third reception means for receiving an update instruction signal which is instruction information indicating an update of the software information;
display control means for displaying, on the monitor, video images corresponding to contents of said certain digital broadcast received by the first reception means; and
update execution means for acquiring the software information through the second reception means and installing the software information thus acquired when the update instruction signal is received by the third reception means.

2. The digital broadcast reception apparatus according to claim 1, further comprising:
decryption information storage means for storing therein firmware information for decrypting encrypted contents of the digital broadcast; and
decryption means that, when encrypted contents of the digital broadcast are received by the first reception means or the second reception means, decrypts the encrypted contents of the digital broadcast thus received, by means of the firmware information stored in the decryption information storage means,
wherein, when the encrypted contents of the digital broadcast are received by the first reception means or the second reception means, the display control means displays, on the monitor, video images corresponding to a result obtained by decrypting the encrypted contents of the digital broadcast by the decryption means, and
the software information is the firmware information stored in the decryption information storage means.

3. The digital broadcast reception apparatus according to claim 2, further comprising:
communication means for communicating with an IC card attached thereto in a detachable manner,
wherein the update execution means, the decryption information storage means, and the decryption means are formed within the IC card which is attached to the communication means.

4. The digital broadcast reception apparatus according to claim 2,
wherein the first reception means, the second reception means, and the third reception means receive information through a cable, and
the third reception means receives the update instruction signal through a predetermined specific frequency band which is different from a frequency band of a broadcast signal.

5. The digital broadcast reception apparatus according to claim 3,
wherein the first reception means, the second reception means, and the third reception means receive information through a cable, and
the third reception means receives the update instruction signal through a predetermined specific frequency band which is different from a frequency band of a broadcast signal.

6. The digital broadcast reception apparatus according to claim 5,
wherein, when the update instruction signal is received by the third reception means, the display control means displays, on the monitor, information indicating that the encrypted contents of the digital broadcast can not be displayed.

7. A digital broadcast reception apparatus configured to be capable of receiving a digital broadcast and outputting contents of the digital broadcast to a monitor in a manner to be visible from outside and configured be capable of receiving firmware information for decrypting encrypted contents of the digital broadcast through a digital broadcast and installing the firmware information, comprising:
first reception means for receiving a certain digital broadcast;
second reception means for receiving another digital broadcast;
third reception means for receiving an update instruction signal which is instruction information indicating an update of the firmware information;
display control means for displaying, on the monitor, video images corresponding to contents of said certain digital broadcast received by the first reception means;
decryption information storage means for storing therein the firmware information;
decryption means that, when encrypted contents of the digital broadcast are received by the first reception means, decrypts the encrypted contents of the digital broadcast thus received, by means of the firmware information stored in the decryption information storage means;
update execution means for acquiring the firmware information through the second reception means and installing the firmware information thus acquired when the update instruction signal is received by the third reception mean; and
communication means for communicating with an IC card attached thereto in a detachable manner,
wherein the update execution means, the decryption information storage means, and the decryption means are formed within the IC card which is attached to the communication means,
when encrypted contents of the digital broadcast are received by the first reception means, the display control means displays, on the monitor, video images corresponding to a result obtained by decrypting the encrypted contents of the digital broadcast by the decryption means,
when the update instruction signal is received by the third reception means, the display control means displays, on the monitor, information indicating that the encrypted contents of the digital broadcast can not be displayed, and
the third reception means receives the update instruction signal through a predetermined specific frequency band which is different from a frequency band of a broadcast signal.
